(19) United States
(12) Patent Application Publication
(10) Pub. No.: US 2006/0086845 A1
(43) Pub. Date: Apr. 27, 2006

(54) Gluing device

(76) Inventors: Wolfgang Holzer, Wallhalben (DE); Thomas Freichel, Lebach (DE); Dan Nielsen, Cambridge (CA)

Correspondence Address: WILLIAM COLLARD;COLLARD & ROE, P.C., 1077 NORTHERN BOULEVARD, ROSLYN, NY, 11576, US

(21) Appl. No.: 11/131,804

(22) Filed: May 18, 2005

(30) Foreign Application Priority Data
May 18, 2004 (DE) 20 2004 008 213.6

(51) Int. Cl. B02C 23/28

(52) U.S. Cl. 241/55

(57) ABSTRACT

A gluing device for gluing wood chips comprises a drum, a plurality of locally fixed discharge devices for glue being disposed inside the drum at least substantially along a line running parallel to a longitudinal axis of the drum, and shedding elements that shed the wood chips falling downward from above laterally relative to a line of the discharge devices. The shedding elements are present above the discharge devices. There are diverting elements, by means of which part of the wood chips falling downward are diverted while falling downward onto the line formed by the discharge devices, with these wood chips being guided between the discharge devices.

### BACKGROUND OF THE INVENTION

1. Field of the Invention

The invention relates to a gluing device for gluing wood chips before further processing thereof.

2. The Prior Art

Gluing devices are known for gluing wood chips before further processing thereof. As an example, further processing can comprise pressing the wood chips to obtain a board. Such a gluing device is provided with a drum, inside which wood chips are disposed. By rotation of the drum, these wood chips are moved in the drum. This drum has noses on its inside surface, the noses being directed substantially toward the central axis of the drum and which are identical in shape and size. Inside the drum, along a line running parallel to the longitudinal axis of the drum, there are a plurality of locally fixed discharge devices for glue. These discharge devices spray the glue out in at least a substantially parallel manner. Thus, the glue is discharged by the discharge devices circularly in a plane or conically. By the rotation of the drum, the wood chips are now swirled up, so that they become glued by the glue sprayed out by the discharge devices. Support surfaces on the inner outside circumference of the drum are formed by the noses. Supported on these support surfaces, the wood chips are transported upward during rotation of the drum. Because of gravity, the wood chips fall from the support surfaces when a certain height is reached. Thus, the wood chips fall past the discharge devices and in the process become glued. In order to prevent wood chips from falling from above directly onto the discharge devices, there are shedding elements, which, for example, can have a gable-roof shape. The wood chips then fall from above onto the shedding elements and slide downward along the shedding elements and fall laterally past the discharge devices.

The discharge devices can be designed as nozzles or also as atomizers or rotary nebulizers. In these rotary nebulizers, the glue drops onto at least one rotating element and is nebulized by the centrifugal forces.

### SUMMARY OF THE INVENTION

It is therefore an object of the present invention to improve the gluing of the wood chips.

This object is achieved according to the present invention by providing further diverting elements, by means of which some of the wood chips falling downward are diverted while falling downward onto the line formed by the discharge devices. These wood chips are guided between the discharge devices.

The wood chips are also preferably guided between the discharge devices. Because of the circular or conical scattering characteristic of the discharge devices, the discharge devices—depending on the spacing of the discharge devices and on the pressure with which the glue is discharged—spray one another with glue when the drum is empty. Thus, due to the fact that wood chips are guided between the discharge devices, this effect can be at least reduced, because the wood chips falling downward between the discharge devices absorb the glue with which the discharge devices would otherwise spray one another.

Thus, the glue can be advantageously better absorbed by the wood chips, because the gluing process is organized more efficiently. This proves to be advantageous, because the glue represents a non-negligible cost aspect for the manufacture of the boards. By more efficient use of the glue, therefore, costs can be advantageously saved during production. A further advantage of more efficient use of the glue consists in the fact that the drum and also the discharge devices are less severely contaminated by unused glue. Cleaning of the drum and also of the discharge devices is comparatively expensive. Thus, production becomes simpler and more efficient when the frequency of the necessary cleaning operations is reduced.

With the diverting elements in conjunction with the shedding elements, therefore, the wood chips fall downward around the discharge devices in a manner comparable to a closed circular curtain and thus absorb the glue sprayed out by the discharge devices.

In a preferred embodiment, the diverting elements form, at least with one part of the shedding elements, a receiving opening for receiving wood chips sliding downward from the shedding elements, these wood chips sliding on the diverting elements in the direction of the line formed by the discharge devices.

At least some of the wood chips are guided to the diverting elements by sliding down on the shedding elements, so that these wood chips are then rerouted between the discharge devices. Thus the diverting elements cooperate with the shedding elements.

In another preferred embodiment, the shedding elements are designed as flat elements disposed in the form of gable roofs above the line of discharge devices. The flat elements are disposed between the discharge devices in the direction of the line of discharge devices having a steeper inclination than the flat elements disposed at the discharge devices in the direction of the line of discharge devices. The flat elements with the gentler inclination are laterally broadened at their lower end as diverting elements in the region of the flat elements with the steeper inclination and in the region of this broadening being elongated compared with the flat elements with the steeper inclination, the broadening being curved or oriented in the direction of the line formed by the line of discharge devices.

The shedding elements and the diverting elements can be prefabricated in one piece and introduced into the gluing drum. Advantageously, these diverting elements are fastened directly on the shedding elements, so that it is not necessary to provide any separate mounting options.

In another embodiment, diverting elements taper toward their lower end.

Therefor, the wood chips become oriented in such a way while falling downward that their broad side is optimally sprayed by glue discharged by the discharge devices. Because of the taper, the edge runs obliquely relative to the direction in which the wood chips slide down, so that the wood chips tilt and become oriented in such a way that, between the discharge devices, they are better oriented for absorption of the glue.

In another embodiment, the diverting elements are designed as a closed surface.

Therefore, it can be advantageously achieved that all wood chips falling downward in the region of these diverting elements are deflected by the diverting elements in a corresponding direction.

In another embodiment, the diverting elements are formed by individual wires or rods.

Thus, the effect that the diverting elements become clogged with glue can be advantageously reduced.

In another embodiment, the diverting elements are mounted completely above the plane that can be reached by the glue discharged by the discharge devices. Thus the diverting elements cannot be contaminated with glue. Thus, problem-free sliding downward of the wood chips is still assured.

In another embodiment, a flat diverting element is mounted so that it can be sprayed by the glue being sprayed out by the discharge devices only from the side along which no wood chips are sliding.

Thus, the wood chips can slide down without problems from the diverting element, without hanging onto it because of the glue.

Due to the special shape of the shedding elements and the diverting elements in the present invention, the spacing of the wood chips to the discharge devices is almost constant. Thus, the wood chips can be impinged upon with an almost constant drop size, with the result in turn that uniform gluing is achieved. Thus, the effects that occur during increasing airborne transit of the drops, such as deformation of the drops or disintegration of the drops, no longer play a decisive role.

In the present invention, it is possible on the whole to provide more than one beam with discharge devices. In particular, therefore, two beams containing discharge devices can also be provided inside the drum. By the shape of the beams with the roof—especially with the shedding elements and the diverting elements—excessive gluing of individual wood chips is avoided. Likewise, insufficient gluing can also be avoided.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a diagram of a gluing drum in a section perpendicular to the longitudinal axis of the drum;

FIG. 2 shows a practical example of a cover of the discharge devices with the shedding elements and the diverting elements;

FIG. 3 shows the diagram of FIG. 2 in a section perpendicular to the longitudinal axis of the gluing drum; and

FIG. 4 shows the diagram of FIG. 2 in side view.

### DETAILED DESCRIPTION OF THE PREFERRED EMBODIMENT

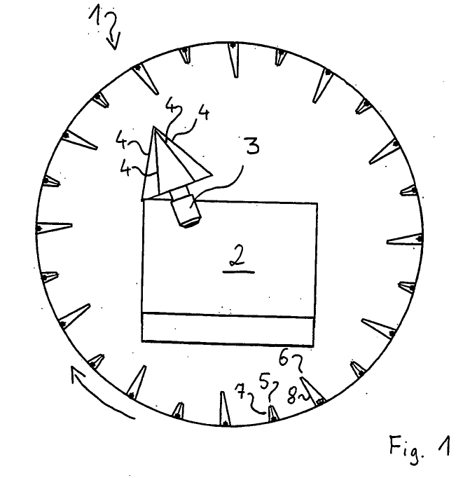

Referring now in detail to the drawings, FIG. 1 shows a gluing drum 1 in a section perpendicular to the longitudinal axis. Discharge opening 2 for the glued wood chips is disposed at the rear end of drum 1. In order to achieve feed of the wood chips in the longitudinal direction of drum 1, drum 1 can be mounted with the longitudinal axis inclined in the direction of discharge opening 2.

In FIG. 1 there is a discharge device 3. The other discharge devices, which are disposed in a row with discharge device 3, are concealed in FIG. 1. Discharge device 3 has a roof 4, which has a slope toward both sides. Wood chips that would fall from above onto discharge device 3 during rotation of drum 1 then fall onto roof 4 and slide down laterally because of its slope, so that these wood chips also fall laterally past discharge device 3.

In the diagram of FIG. 1, noses 5 and 6 can be seen on the inside of the cylindrical surface of drum 1. In the illustrated practical example there are indicated two noses 5 and 6. It can be seen that such noses are disposed circumferentially and repeatedly.

In this connection, noses 5 are shorter than noses 6. Furthermore, support surface 7 of the shorter nose 5 has a steeper inclination than support surface 8 of longer nose 6. The dwell time of the wood chips on the respective support surfaces 7, 8 is different during rotation of drum 1. If the wood chips are transported upward on the respective support surfaces 7, 8 during rotation, the wood chips begin to slide off the respective support surfaces 7, 8 when their inclination is directed downward toward the free end of support surfaces 7, 8 due to rotation of the drum.

Depending on the inclination of support surfaces 7, 8, the wood chips supported thereon begin to slide downward from support surfaces 7, 8 at different angles of rotation of drum 1.

The instant (or angle of rotation of drum 1) at which the wood chips have then reached the free end of the respective support surface 7 or 8 and fall downward freely can therefore be adjusted by the length of support surfaces 7 and 8 (or in other words the length of noses 5 and 6) as well as the inclination of the respective support surfaces 7 and 8.

In this connection it is possible to configure noses 5 and 6 differently regarding both length and inclination of their support surfaces 7 and 8. This can be seen in FIG. 1. It is also possible, however, to configure noses 5 and 6 differently as regards only one of these parameters. This means that noses 5 and 6 can be equally long with different inclinations of support surfaces 7 and 8 or can be differently long with equal inclinations of support surfaces 7 and 8.

Advantageously, noses 5 and 6 are configured differently in pairs disposed next to one another, so that, from noses 5 and 6 following one another, the wood chips fall down respectively on different sides of the line formed by discharge devices 3.

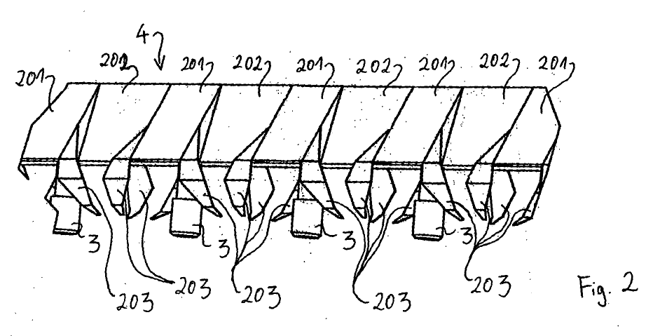

FIG. 2 shows a practical example of a roof 4 of discharge devices 3 with shedding elements 201, 202 and diverting elements 203.

In this connection it can be seen that shedding elements 201 and shedding elements 202 are disposed along the line formed by discharge devices 3. Shedding elements 202 have a steeper slope than shedding elements 201. Shedding elements 201 with the gentler slope are disposed at the positions of discharge devices 3 along the line formed by discharge devices 3. Shedding elements 202 with the steeper slope are disposed at the position between discharge devices 3 along the line formed by discharge devices 3.

Shedding elements 201 and 202 are flat elements 201, 202 disposed in the form of gable roofs above the line of discharge devices 3. Flat elements 202, which are disposed between discharge devices 3 in the direction of the line of discharge devices 3, have a steeper inclination than flat elements 201, which are disposed at discharge devices 3 in the direction of the line of discharge devices 3. Furthermore, at their lower end, flat elements 201 with the gentler inclination are laterally broadened as diverting elements 203 in the region of flat elements 202 with the steeper inclination. In the region of this broadening, flat elements 201 are elongated compared with flat elements 202 with the steeper inclination, the broadening being curved or oriented in the direction of the line formed by the line of discharge devices 3.

Thus, wood chips that slide down one of the flat elements 202 can be advantageously deflected at least partially by one of the diverting elements 203, so that these wood chips fall downward between discharge devices 3. The glue discharged by the discharge devices is therefore used efficiently.

Thus, diverting elements 203 form, together with shedding elements 202, a receiving opening for receiving wood chips sliding down from shedding elements 202. These fall from the outside of shedding elements 202 onto the inside of diverting elements 203 and are deflected in the direction of the line formed by discharge devices 3.

Diverting elements 203 can be mounted as straight components with a corresponding orientation or can also be correspondingly curved or kinked, so that the corresponding change of direction of the downwardly falling wood chips is produced.

In order to allow the wood chips to fall downward in a manner comparable with a curtain, it is preferable if the diverting elements 203 taper downward to a tip. Compared with a straight bottom end edge parallel to the line formed by discharge devices 3, discharge devices 3 are largely surrounded on all sides by downwardly falling wood chips even in the region between discharge devices 3. Thus, the discharged glue is absorbed optimally by the wood chips.

Because diverting elements 203 taper toward their end (ending in a tip in the illustrated practical example), there is a further advantage that the wood chips, while being tipped over the obliquely running edge, change the orientation of their broad surface to the effect that the wood chips fall downward with this broad side in a manner oblique or even perpendicular relative to the orientation of the connecting line of discharge devices 3. Therefore, the downwardly falling wood chips are also optimally glued, because the glue is then applied predominantly on the broad side.

In the illustrated practical example, it can be seen that diverting elements 203 are formed as closed surfaces. Furthermore, these diverting elements 203 run above discharge devices 203. By each individual one of these features, it is advantageously achieved that the surface along which the wood chips slide during falling downward is not contaminated with glue by the discharge devices. This is ensured by the combination of these features in the illustrated example.

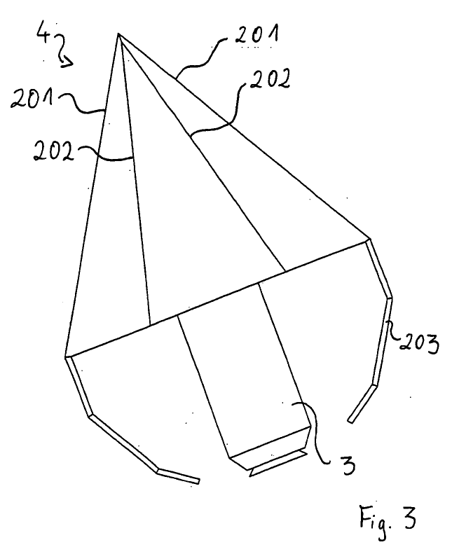

FIG. 3 shows the diagram of FIG. 2 in a section perpendicular to the longitudinal axis of gluing drum 1. Identical parts therein are denoted by identical reference numerals.

Diverting elements 203 are attached to shedding elements 201 and are inwardly curved in the direction of the discharge openings of discharge devices 3.

Also shown are shedding elements 202, from which wood chips slide down on the outside in such a manner than they are then further deflected on the inside of diverting elements 203 in the direction of the line formed by discharge devices 3 and fall downward between discharge devices 3.

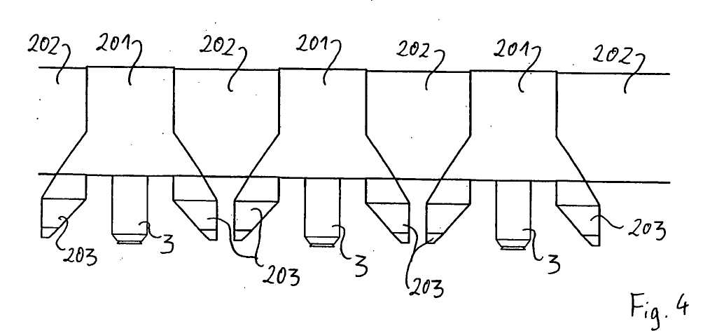

FIG. 4 shows the diagram of FIG. 2 in a side view. Here also identical parts are again denoted by identical reference numerals.

In the illustrated embodiments, diverting elements 203 can either be configured as a closed surface made from a sheet-metal part or else can be formed from individual wires or rods. Thus, glue or glued wood chips can be prevented from accumulate on diverting elements 203.

Accordingly, while only a few embodiments of the present invention have been shown and described, it is obvious that many changes and modifications may be made thereunto without departing from the spirit and scope of the invention.

What is claimed is:

1. A gluing device for gluing wood chips, comprising:
a drum;
a plurality of locally fixed discharge devices for glue, said discharge devices being disposed inside the drum at least substantially along a line running parallel to a longitudinal axis of the drum;
shedding elements disposed above the discharge devices in the drum, said shedding elements shedding the wood chips so that they fall downward from above the line of said discharge devices; and
diverting elements, by means of which part of the wood chips falling downward are diverted while falling downward onto the line formed by the discharge devices, wherein the wood chips are guided between the discharge devices by the diverting elements.

2. A gluing device according to claim 1, wherein the diverting elements are formed in one part with the shedding elements and form a receiving opening for receiving wood chips sliding downward from the shedding elements, these wood chips sliding on the diverting elements in the direction of the line formed by the discharge devices.

3. A gluing device according to claim 1, wherein the shedding elements are designed as flat elements disposed in the form of gable roofs above the line of discharge devices, wherein some of the flat elements are disposed between the discharge devices in a direction of the line of discharge devices and have a steeper inclination than flat elements disposed at the discharge devices in the direction of the line of discharge devices, the flat elements with a less steep inclination being laterally broadened at their lower end as diverting elements in a region of the flat elements with the steeper inclination, and in the region of this broadening being elongated compared with the flat elements with the steeper inclination, the broadening being curved or oriented in a direction of a line formed by the line of discharge devices.

4. A gluing device according to claim 1, wherein the diverting elements taper toward their lower end.

5. A gluing device according to claim 1, wherein the diverting elements are designed as a closed surface.

6. A gluing device according to claim 1, wherein the diverting elements are formed by individual wires or rods.

7. A gluing device according to claim 1, wherein the diverting elements are mounted completely above a plane that is reachable by glue discharged by the discharge devices.

8. A gluing device according to claim 5, wherein the diverting elements are mounted so that they can be sprayed by the glue sprayed out by the discharge devices only from a side along which no wood chips are sliding.
